(19) United States
(12) Patent Application Publication
(10) Pub. No.: US 2015/0256601 A1
(43) Pub. Date: Sep. 10, 2015

(54) SYSTEM AND METHOD FOR EFFICIENT CONTENT CACHING IN A STREAMING STORAGE

(71) Applicant: PALO ALTO RESEARCH CENTER INCORPORATED, PALO ALTO, CA (US)

(72) Inventor: Marc E. Mosko, Santa Cruz, CA (US)

(21) Appl. No.: 14/202,553

(22) Filed: Mar. 10, 2014

(51) Int. Cl. H04L 29/08; H04L 29/06

(52) U.S. Cl. CPC H04L 67/10; H04L 65/608

(57) ABSTRACT

One embodiment of the present invention provides a system for caching content data to a streaming storage in a content-centric network (CCN). The system maintains an in-memory index table. A respective entry in the index table specifies a disk location in the streaming storage. During operation, the system receives a content packet, calculates an index for the content packet based on one or more header fields included in the content packet, maps the calculated index to a corresponding entry in the in-memory index table, writes the content packet into the streaming storage, and updates the mapped entry in the in-memory index table based on a disk location to which the content packet is written.

### RELATED APPLICATIONS

The subject matter of this application is related to the subject matter in the following applications:
U.S. patent application Ser. No. 14/065,691 (Attorney Docket No. PARC-20130997US01), entitled “SYSTEM AND METHOD FOR HASH-BASED FORWARDING OF PACKETS WITH HIERARCHICALLY STRUCTURED VARIABLE-LENGTH IDENTIFIERS,” by inventors Marc E. Mosko and Michael F. Plass, filed 29 Oct. 2013;
U.S. patent application Ser. No. 14/067,857 (Attorney Docket No. PARC-20130874US01), entitled “SYSTEM AND METHOD FOR MINIMUM PATH MTU DISCOVERY IN CONTENT CENTRIC NETWORKS,” by inventor Marc E. Mosko, filed 30 Oct. 2013; and
U.S. patent application Ser. No. 14/069,286 (Attorney Docket No. PARC-20130998US02), entitled “HASH-BASED FORWARDING OF PACKETS WITH HIERARCHICALLY STRUCTURED VARIABLE-LENGTH IDENTIFIERS OVER ETHERNET,” by inventors Marc E. Mosko, Ramesh C. Ayyagari, and Subbiah Kandasamy, filed 31 Oct. 2013;
   the disclosures of which herein are incorporated by reference in their entirety.

### BACKGROUND

1. Field

The present disclosure relates generally to a content-centric network (CCN). More specifically, the present disclosure relates to a system and method for efficient content caching in CCNs.

2. Related Art

The proliferation of the Internet and e-commerce continues to fuel revolutionary changes in the network industry. Today, a significant number of information exchanges, from online movie viewing to daily news delivery, retail sales, and instant messaging, are conducted online. An increasing number of Internet applications are also becoming mobile. However, the current Internet operates on a largely location-based addressing scheme. The two most ubiquitous protocols, the Internet Protocol (IP) and Ethernet protocol, are both based on location-based addresses. That is, a consumer of content can only receive the content by explicitly requesting the content from an address (e.g., IP address or Ethernet media access control (MAC) address) closely associated with a physical object or location. This restrictive addressing scheme is becoming progressively more inadequate for meeting the ever-changing network demands.

Recently, content-centric network (CCN) architectures have been proposed in the industry. CCN brings a new approach to content transport. Instead of having network traffic viewed at the application level as end-to-end conversations over which content travels, content is requested or returned based on its unique name, and the network is responsible for routing content from the provider to the consumer. Note that content includes data that can be transported in the communication system, including any form of data such as text, images, video, and/or audio. A consumer and a provider can be a person at a computer or an automated process inside or outside the CCN. A piece of content can refer to the entire content or a respective portion of the content. For example, a newspaper article might be represented by multiple pieces of content embodied as data packets. A piece of content can also be associated with metadata describing or augmenting the piece of content with information such as authentication data, creation date, content owner, etc.

In CCN, content objects and interests are identified by their names, which is typically a hierarchically structured variable-length identifier (HSVLI). When an interest in a piece of content is received at a CCN node, a local content cache is checked to see if the content being requested exists. In addition, the CCN node may selectively cache popular content objects to increase the network response rate.

### SUMMARY

One embodiment of the present invention provides a system for caching content data to a streaming storage in a content-centric network (CCN). The system maintains an in-memory index table. A respective entry in the index table specifies a disk location in the streaming storage. During operation, the system receives a content packet, calculates an index for the content packet based on one or more header fields included in the content packet, maps the calculated index to a corresponding entry in the in-memory index table, writes the content packet into the streaming storage, and updates the mapped entry in the in-memory index table based on a disk location to which the content packet is written.

In a variation on this embodiment, the system maintains an in-memory operation buffer configured to reference pending disk operations.

In a further variation on this embodiment, the in-memory operation buffer includes a linked list identifying a set of pending disk operations on a same block in the streaming storage.

In a variation on this embodiment, the one or more header fields include at least one of: a similarity hash and a forwarding hash.

In a further variation, calculating the index involves hashing a combination of the similarity hash and the forwarding hash to a shorter-length string.

In a variation on this embodiment, the system maintains a tail pointer configured to point to a next available disk location for writing the content packet, and updates the tail pointer subsequent to writing the content packet in the streaming storage.

In a variation on this embodiment, the streaming storage includes a plurality of disks, and the respective entry in the index table includes a disk number and a block number.

In a variation on this embodiment, the system receives an interest packet, calculates an index of the interest packet, maps the index of the interest packet to an entry in the in-memory index table, extracts a disk location from the entry mapped to the index of the interest, reading content data stored at the extracted disk location, and returns the content data as a response to the interest packet.

In a further variation, the system increases a popularity level associated with the content data, and in response to determining that the popularity level associated with the content data being higher than a predetermined level, the system moves the content data to a popular sector within the streaming storage to prevent future over-written of the content data.

### BRIEF DESCRIPTION OF THE FIGURES

FIG. 1 illustrates an exemplary architecture of a network, in accordance with an embodiment of the present invention.

FIG. 2 presents a diagram illustrating an exemplary mapping between the SH-FH combination and the disk location, in accordance with an embodiment of the present invention.

FIG. 3 presents a diagram illustrating the format of an exemplary disk block, in accordance with an embodiment of the present invention.

FIG. 4 presents a diagram illustrating an exemplary disk block containing Content Object fragments, in accordance with an embodiment of the present invention.

FIG. 5 presents a diagram presenting an exemplary architecture of a CCN-enabled node, in accordance with an embodiment of the present invention.

FIG. 6 presents a diagram illustrating exemplary data structures used for content caching in a streaming storage, in accordance with an embodiment of the present invention.

FIG. 7A presents a flowchart illustrating an exemplary first-time initialization process of the streaming storage, in accordance with an embodiment of the present invention.

FIG. 7B presents a flowchart illustrating an exemplary initialization process after a clean shut down, in accordance with an embodiment of the present invention.

FIG. 7C presents a flowchart illustrating an exemplary initialization process after a dirty shut down, in accordance with an embodiment of the present invention.

FIG. 8 presents a flowchart illustrating the process of processing an Interest, in accordance with an embodiment of the present invention

FIG. 9 presents a diagram illustrating a block read process, in accordance with an embodiment of the present invention.

FIG. 10 presents a diagram illustrating the process of processing a received Content Object in the streaming storage, in accordance with an embodiment of the present invention.

FIG. 11 presents a diagram illustrating an exemplary verification process after a DMA read in response to an Interest, in accordance with an embodiment of the present invention.

FIG. 12 presents a diagram illustrating an exemplary system process after a DMA read in response to a Content Object, in accordance with an embodiment of the present invention.

FIG. 13 illustrates an exemplary system for content caching in a streaming storage, in accordance with an embodiment.

In the figures, like reference numerals refer to the same figure elements.

### DETAILED DESCRIPTION

### Overview

Embodiments of the present invention provide a system and method for caching content data in a streaming storage and creating an in-memory index table to allow fast content retrieval. More specifically, CCN names or the corresponding hash functions of content objects are hashed down to smaller-size index strings, which are used to index an in-memory cache table. Entries in the in-memory cache table identify the corresponding locations to which the content objects are cached. Due to the disk-access latency, the system establishes in-memory operation buffers to hold interest and content objects while they are waiting to be processed.

In general, CCN uses two types of messages: Interests and Content Objects. An Interest carries the hierarchically structured variable-length identifier (HSVLI), also called the “name,” of a Content Object and serves as a request for that object. If a network element (e.g., router) receives multiple interests for the same name, it may aggregate those interests. A network element along the path of the Interest with a matching Content Object may cache and return that object, satisfying the Interest. The Content Object follows the reverse path of the Interest to the origin(s) of the Interest. A Content Object contains, among other information, the same HSVLI, the object's payload, and cryptographic information used to bind the HSVLI to the payload.

The terms used in the present disclosure are generally defined as follows (but their interpretation is not limited to such):
“HSVLI:” Hierarchically structured variable-length identifier, also called a Name. It is an ordered list of Name Components, which may be variable length octet strings. In human-readable form, it can be represented in a format such as ccnx:/path/part. There is not a host or query string. As mentioned above, HSVLIs refer to content, and it is desirable that they be able to represent organizational structures for content and be at least partially meaningful to humans. An individual component of an HSVLI may have an arbitrary length. Furthermore, HSVLIs can have explicitly delimited components, can include any sequence of bytes, and are not limited to human-readable characters. A longest-prefix-match lookup is important in forwarding packets with HSVLIs. For example, an HSVLI indicating an interest in “/parc/home/bob” will match both “/parc/home/bob/test.txt” and “/parc/home/bob/bar.txt.” The longest match, in terms of the number of name components, is considered the best because it is the most specific.
“Interest:” A request for a Content Object. The Interest specifies an HSVLI name prefix and other optional selectors that can be used to choose among multiple objects with the same name prefix. Any Content Object whose name matches the Interest name prefix and selectors satisfies the Interest.
“Content Object:” A data object sent in response to an Interest. It has an HSVLI name and a Contents payload that are bound together via a cryptographic signature. Optionally, all Content Objects have an implicit terminal name component made up of the SHA-256 digest of the Content Object. In one embodiment, the implicit digest is not transferred on the wire, but is computed at each hop, if needed.
“Similarity Hash:” In an Interest, the Name and several fields called Selectors limit the possible content objects that match the interest. Taken together, they uniquely identify the query in the Interest. The Similarity Hash is a hash over those fields. Two interests with the same SH are considered identical queries.
“Forwarding Hash:” The forwarding hash (FH) represents the longest matching prefix in the routing tables in various forwarding devices (e.g., routers, switches, etc.) along a data path that matches the Interest name. FH is computed based on one or more components of an Interest packet's name. In general, the source node of an Interest packet may compute FH based on the highest-level hierarchy of the name components (wherein the highest hierarchy is “/”).

As mentioned before, an HSVLI indicates a piece of content, is hierarchically structured, and includes contiguous components ordered from a most general level to a most specific level. The length of a respective HSVLI is not fixed. In content-centric networks, unlike a conventional IP network, a packet may be identified by an HSVLI. For example, “abcd/bob/papers/ccn/news” could be the name of the content and identifies the corresponding packet(s), i.e., the “news” article from the “ccn” collection of papers for a user named “Bob” at the organization named “ABCD.” To request a piece of content, a node expresses (e.g., broadcasts) an interest in that content by the content's name. An interest in a piece of content can be a query for the content according to the content's name or identifier. The content, if available in the network, is routed back to it from any node that stores the content. The routing infrastructure intelligently propagates the interest to the prospective nodes that are likely to have the information and then carries available content back along the path which the interest traversed.

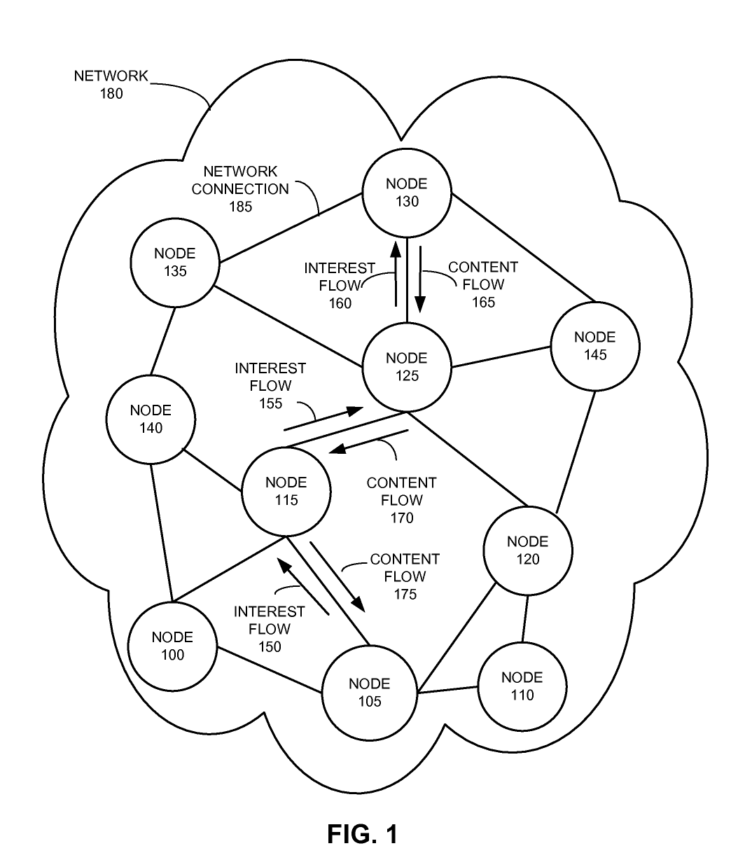

FIG. 1 illustrates an exemplary architecture of a network, in accordance with an embodiment of the present invention. In this example, a network 180 comprises nodes 100-145. Each node in the network is coupled to one or more other nodes. Network connection 185 is an example of such a connection. The network connection is shown as a solid line, but each line could also represent sub-networks or super-networks, which can couple one node to another node. Network 180 can be content-centric, a local network, a super-network, or a sub-network. Each of these networks can be interconnected so that a node in one network can reach a node in other networks. The network connection can be broadband, wireless, telephonic, satellite, or any type of network connection. A node can be a computer system, an end-point representing users, and/or a device that can generate interest or originate content.

In accordance with an embodiment of the present invention, a consumer can generate an Interest in a piece of content and then send that Interest to a node in network 180. The piece of content can be stored at a node in network 180 by a publisher or content provider, who can be located inside or outside the network. For example, in FIG. 1, the Interest in a piece of content originates at node 105. If the content is not available at the node, the Interest flows to one or more nodes coupled to the first node. For example, in FIG. 1, the Interest flows (interest flow 150) to node 115, which does not have the content available. Next, the Interest flows (interest flow 155) from node 115 to node 125, which again does not have the content. The Interest then flows (interest flow 160) to node 130, which does have the content available. The flow of the content then retraces its path in reverse (content flows 165, 170, and 175) until it reaches node 105, where the content is delivered. Other processes such as authentication can be involved in the flow of content.

In network 180, any number of intermediate nodes (nodes 100-145) in the path between a content holder (node 130) and the Interest generation node (node 105) can participate in caching local copies of the content as it travels across the network. Caching reduces the network load for a second subscriber located in proximity to other subscribers by implicitly sharing access to the locally cached content.

### Streaming Storage in CCN

As described previously, in CCN, it is desirable to have intermediate nodes caching local copies of the content. This requires the intermediate nodes to have a large storage capacity because the amount of content flow through the network can be huge. In addition, the speed of the content data flow can be high, as a fast CCN router is able to process tens of millions of content packets per second. For example, a 100 Gbps (Giga bit per second) line card can process over 4 million objects per second (assuming that the size of the Interests and Objects is 1500 bytes each). Therefore, a fast, efficient caching mechanism is needed.

In some embodiments of the present invention, a streaming storage, which allows the content data (such as video files) to be cached as they are being received and allows new data to over-write old data, is used for content caching. To cache large amount of data at high speed, the streaming storage may include multiple large-capacity (such as 250 GB or 1 TB) disks, which can include magnetic hard drives or solid state drives (SSDs). Note that by implementing multiple disks, parallel streaming can be used to achieve high throughput. A typical disk can achieve a sustained throughput of up to 150 MB/sec. For example, Seagate® (registered trademark of Seagate Technology of Cupertino, Calif.) 3.5″ video hard drives can sustain read and write at a speed of 146 MB/s. To store data at 12.5 GB/sec, the system needs to write the data over 100 disks in parallel. Solid state drives (SSDs) can provide higher throughput. To store the same 12.5 GB/sec data, only about 50 SSDs may be needed.

In addition to parallel operation, to ensure high speed, an efficient indexing mechanism is implemented. In some embodiments, an in-memory cache table is created with entries pointing to disk locations of corresponding cached content packets. Moreover, to ensure fast table lookup, the in-memory cache table is indexed with strings that are sufficiently short. When hashing-forwarding is implemented in the network, each Content Object or Interest includes a hash header, which includes a similarity hash (SH) and a forwarding hash (FH). The similarity hash is computed to uniquely identify a piece of content, and can be a hash of the name and one or more fields in the content packet. The forwarding hash is computed based on one or more components of an Interest packet's name. Detailed descriptions of the hash forwarding, the similarity hash, and the forwarding hash can be found in U.S. patent application Ser. No. 14/065,961 (Attorney Docket No. PARC-20130997US01), entitled “SYSTEM AND METHOD FOR HASH-BASED FORWARDING OF PACKETS WITH HIERARCHICALLY STRUCTURED VARIABLE-LENGTH IDENTIFIERS,” by inventors Marc E. Mosko and Michael F. Plass, filed 29 Oct. 2013, the disclosure of which herein is incorporated by reference in its entirety.

In some embodiments, the SH and/or FH may be computed at each hop, if those values are not already included in the packet header. A system may also use other values than stated SH and FH for indexing purposes. For example, a system could only cache Content Objects by their Content Object Hash, which the SHA-256 hash of the entire Content Object, and only respond to Interests that ask for data by hash value.

The combination of SH and FH can uniquely identify an Interest and a Content Object in response to the Interest. Although it may be possible to use such a combination to index the in-memory cache table, such a combination may include a long bit string, making index lookup time consuming. For example, the SH and the FH each may be 128-bit long, and their combination (by concatenation) will be 256-bit long, which can make table lookup computational costly. In some embodiments, to simplify the table lookup process, the SH-FH combination is hashed down to a shorter length index. For example, the 256-bit SH-FH combination can be hashed down to a 34-bit string, which can then be used to index the in-memory cache table. It is also possible to use an even shorter string, such as one having a length between 28 and 32 bits, as index. Entries in the cache table indicate the locations of Content Objects stored in the streaming storage. For example, an entry may include a disk number, a block number, and a count indicating the number of blocks occupied by the corresponding Content Object. Additional fields may also be included in the cache entry. Note that collision-resistant hash functions should be used to hash the SH-FH combination to ensure that attackers cannot easily cause the system to overwrite existing content. In some embodiments, the system uses lower bits of CRC-64-ECMA-182 to hash the SH-FH combination. Note that this hash function is very fast to calculate, and can be available in hardware. Other types of algorithms, such as the FVN-1a hash algorithm or the SipHash or other hardware-supported hash functions, can also be used to calculate the index.

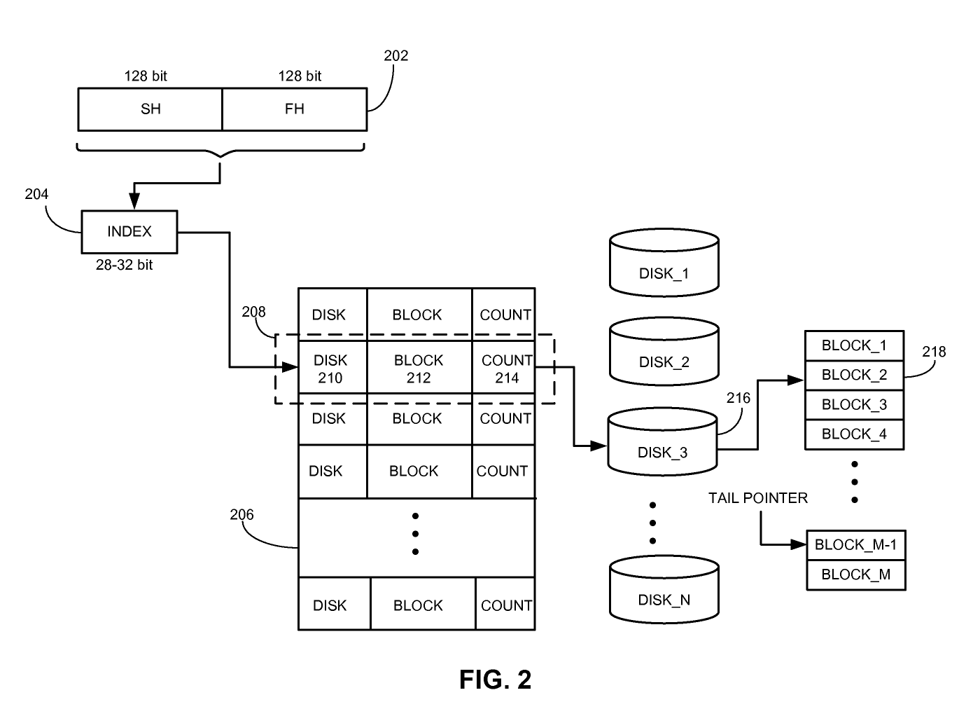

FIG. 2 presents a diagram illustrating an exemplary mapping between the SH-FH combination and the disk location, in accordance with an embodiment of the present invention. In FIG. 2, a 256-bit SH-FH combined string 202 (which includes the SH and the FH fields of a Content Object) is hashed down to a shorter-length index 204. In some embodiments, shorter-length index 204 can be between 28 and 32 bits long. Shorter-length index 204 is mapped to an entry in a cache table 206, such as an entry 208. Each entry in cache table 206 can include a disk-number field 210 (which can be 8-bit long), a block-number field 212 (which can be 28-bit long), and a block-count field 214 (which can be 4-bit long). Disk-number field 210 indicates at which disk (such as a disk 216) the corresponding Content Object is located. Block-number field 212 indicates, within the disk, starting from which block (such as a block 218) the Content Object occupies. Block-count field 214 indicates the total number of blocks the Content Object occupies. Note that, each time a new Content Object is cached into the streaming storage, a corresponding entry (based on the SH-FH combination) in cache table 206 is updated. More specifically, the disk number field and the block number field in the cache entry are updated to reflect the location to which the Content Object is cached.

To ensure that incoming content packets are cached in the streaming storage consecutively, the system maintains a tail pointer 220, which indicates the next available block to use. In some embodiments, the tail pointer includes the disk number and the block number. When a new Content Object is written into the streaming storage, the system looks up the current tail pointer, updates the corresponding entry in the cache table using the tail pointer, and moves the tail pointer forward according to number of blocks needed for storing the Content Object. Note that the tail pointer is incremented modulo to the disk size. When the end of a disk is reached (in blocks), the tail pointer wraps around to the beginning of the disk. In the example shown in FIG. 2 where multiple disks are used, the wrap around can include the disk number. Alternatively, the tail pointer may increment over disks fist, then over blocks on a disk as the slower loop. As the tail pointer wraps around, the system needs to first read a block and determine whether that block is used by an index entry (an entry in the cache table). If so, the system invalidates the index entry before writing the new index entry to the indicated location, including a disk-block header. This is done for each block written for a contiguous Content Object.

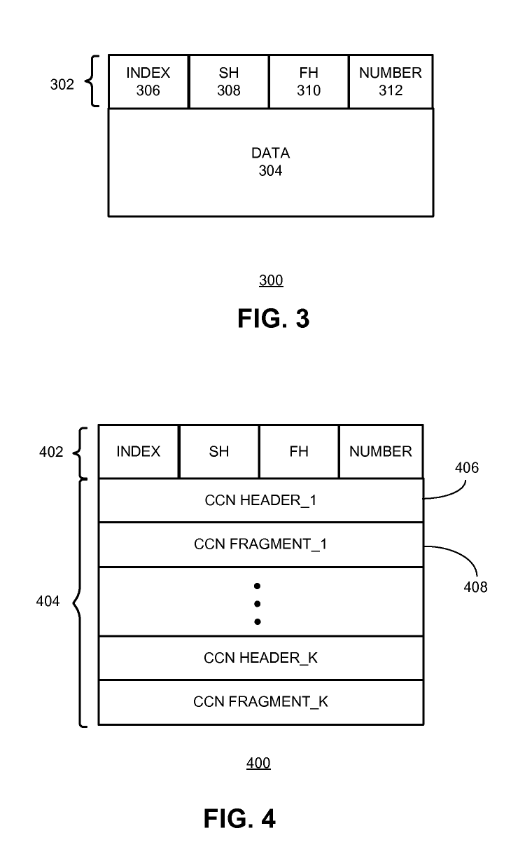

FIG. 3 presents a diagram illustrating the format of an exemplary disk block, in accordance with an embodiment of the present invention. In FIG. 3, a disk block 300 includes a disk-block header field 302 and a data field 304. Disk-block header field 302 further includes an index field 306, a SH field 308, an FH field 310, and a number field 312. Index filed 306 includes the hashed down index of the SH-FH combination, SH field 308 includes the similarity hash, FH field 310 includes the forwarding hash, and number field 312 includes the block sequence (if the Content Object occupies multiple consecutive blocks). For example, a number “2” in number field 312 indicates that the current block is the third block counting from the beginning (block “0”) of the Content Object. In some embodiments, the block size is 4 KB (kilobyte). For example, for a CCN Content Object of up to 64 KB, 16 4-KB blocks would be needed, requiring a O-bit block-count field in the cache table entry. It is also possible to have other block sizes.

FIG. 4 presents a diagram illustrating an exemplary disk block containing Content Object fragments, in accordance with an embodiment of the present invention. In FIG. 4, a disk block 400 includes a disk-block header field 402 and a data field 404. Disk-block header field 402 is similar to disk-block header field 302, and includes an index field, an SH field, an FH field, and a number field. Data field 404 includes a number of Content Object fragments, written in the received order. Note that each fragment includes a CCN header, such as a CCN header 406, and a CCN fragment data field, such as a CCN fragment data field 408. Fragments do not need to be written in order. Note that here we assume that no fragment is larger than the disk-block size minus the disk-block header size. If a CCN fragment spans multiple disk blocks, a slight modification to the caching algorithm may be needed. Detailed description of the fragment header of Content Objects in CCNs can be found in U.S. patent application Ser. No. 14/067,857 (Attorney Docket No. PARC-20130874US01), entitled “SYSTEM AND METHOD FOR MINIMUM PATH MTU DISCOVERY IN CONTENT CENTRIC NETWORKS,” by inventor Marc E. Mosko, filed 30 Oct. 2013, the disclosure of which herein is incorporated by reference in its entirety.

To ensure high-speed read and write, in some embodiments, the system maintains the index table (or the cache table) in the fast memory, such as a random access memory (RAM). Alternatively, the system may use a disk-based index that is page swapped to the RAM. The in-memory index needs to be large enough to cover all 4 KB blocks in the streaming storage, meaning that the in-memory cache table needs to include sufficient number of index entries. For a streaming storage with up to 1 TB (terabyte) capacity, 256 millions of index entries would be needed. If each entry is 40-bit long, the cache table would need 10.24 GB of RAM. For a system with 16 TB streaming storage, 160 GB of RAM would be needed. In some embodiments, the system may include 100 disks, each with a 250 GB capacity, thus providing a total storage capacity of 25 TB. As described previously, using 100 disks in parallel can provide a streaming speed over 12.5 GB/s.

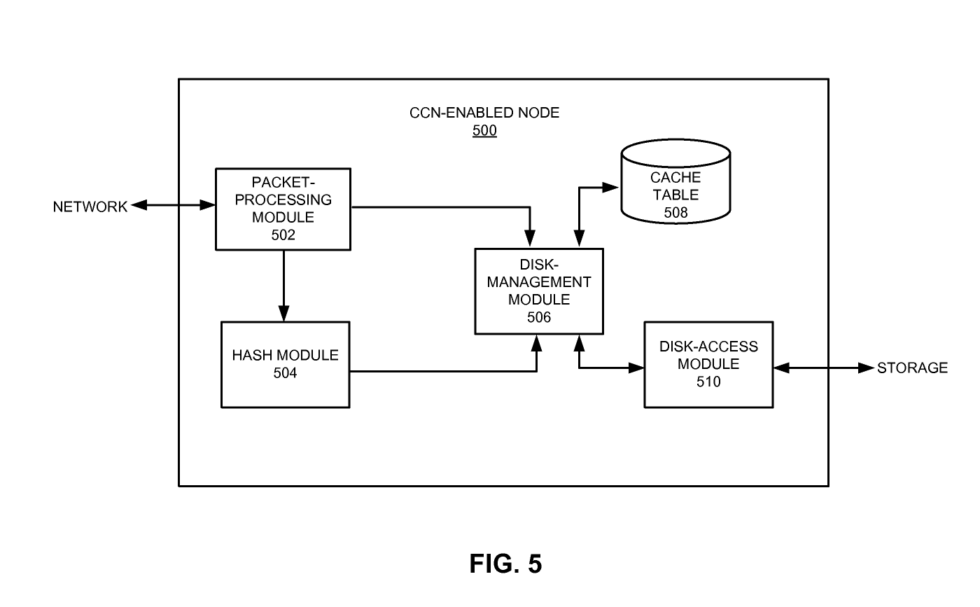

FIG. 5 presents a diagram presenting an exemplary architecture of a CCN-enabled node, in accordance with an embodiment of the present invention. In FIG. 5, CCN-enabled node 500 includes a packet-processing module 502, a hash module 504, a disk-management modules 506, a cache table 508, and a disk-access module 510. Packet-processing module 502 is responsible for processing the received packets, either Interests or Content Objects. In some embodiments, CCN-enabled node 500 implements hash forwarding, and packet-processing module 502 extracts similarity hash and forwarding hash from the headers of the received packets. Hash module 504 is responsible for hashing down the SH-FH combined string to a shorter-length index string. In some embodiments, hash module 504 can use certain collision-resistance hash functions, such as the lower bits of CRC-64-ECMA-182 and the FVN-1a algorithm. Disk-management module 506 is responsible for maintaining cache table 508 which maps the indices to disk locations. Moreover, disk-management module 506 controls disk-access module 510 which accesses the appropriate disk locations for read and write operations. In some embodiments, when writing to the streaming storage, disk-access module 510 adds a disk-block header to each content data block. Note that other data structures, such as packet buffers or operation buffers, may also be needed to enable caching of the content data and are not included in FIG. 5.

Due to the disk-access (read or write) latency, an operation buffer is needed to hold Interest and Content Objects before their disk operations are performed. In some embodiments, to ensure high speed, the operation buffer is also maintained in the fast memory. This in-memory operation buffer can be implemented as a circular buffer or a free list. More specifically, the operation buffer holds pointers to the packet buffer to allow multiple operations waiting for the same disk block to be performed sequentially.

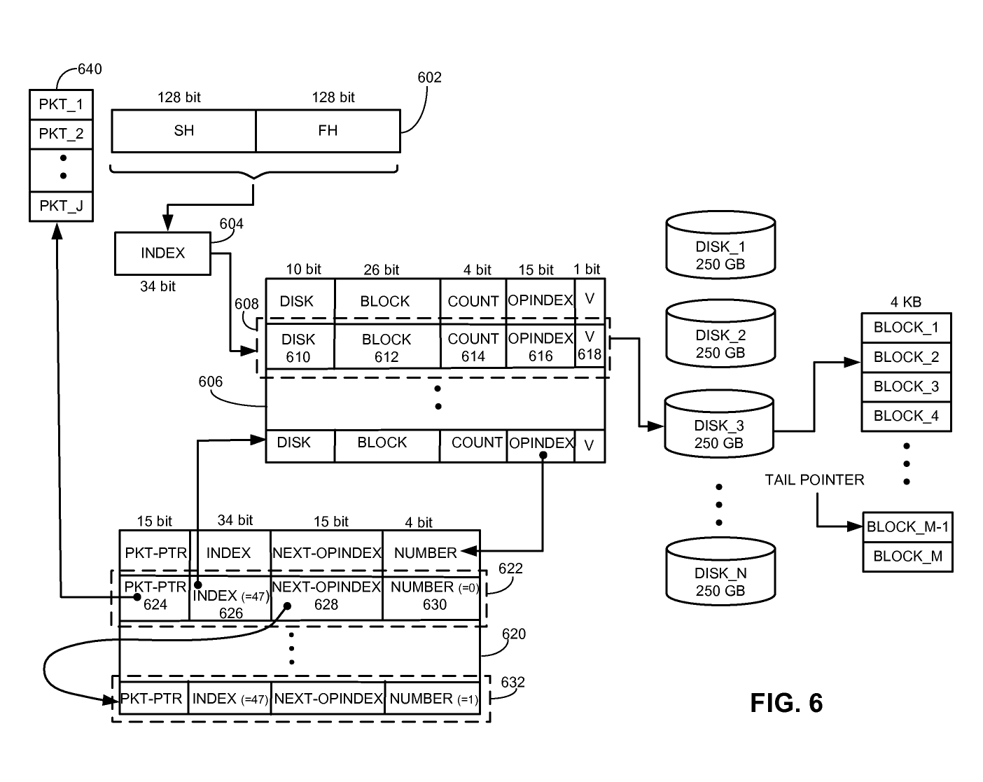

FIG. 6 presents a diagram illustrating exemplary data structures used for content caching in a streaming storage, in accordance with an embodiment of the present invention. In FIG. 6, a 256-bit SH-FH combined string 602 extracted from a packet is hashed down to a shorter-length index 604. In the example shown in FIG. 6, index 604 is 34-bit long, meaning that up to Ser. No. 17/179,869,184 table entries are possible. In some embodiments, the 34-bit index is extracted from a CRC-64-ECMA-180 digest. Shorter-length index 604 maps to an entry in an index table 606, such as an entry 608. In the example shown in FIG. 6, each entry in cache table 606 is at minimum 56 bits long, with a 10-bit disk-number field 610, a 26-bit block-number field 612, a 4-bit block-count field 614, a 15-bit operation-index field 616, and a 1-bit validation field 618. Disk-number field 610, block-number field 612, and block-count field 614 are similar to fields 210, 212, and 214. Operation-index (opindex) field 616 stores the 15-bit index of an operation buffer 620, which can be a contiguous memory. Validation field 618 indicates whether the cache table entry is valid. In some embodiments, the system actually stores the cache table entries in 64-bit words to align table entries with CPU cache lines. Using the 64-bit words, cache table 606 would need 128 GB of RAM.

Each entry in operation buffer 620 corresponds to a pending read or write operation. In some embodiments, an operation buffer entry, such as entry 622, includes a packet-pointer field 624 (which can be 15-bit long), an index field 626 (which can map to an entry in hash table 606), a next-operation-index field 628, and a number field 630. Packet-pointer field 624 stores a pointer to a packet in packet buffer 640, which allows 32,768 in-process packets. Next-operation-index field 628 stores a singly linked list pointer to a next entry in operation buffer 620 waiting for the same disk operation, if multiple operations are waiting for accessing the same disk block. Number field 630 is similar to number field 312, indicating the sequence number of the block among the blocks occupied by the same Content Object. In the example shown in FIG. 6, two operation buffer entries (entry 622 and entry 632) are waiting for the same disk block; both have the same index but different number field, meaning that they belong to the different blocks of the same Content Object. The pointer stored in next-operation-index field 628 points to entry 632, which waits for the second block of the SH-FH index entry.

The mapping between entries in index table 606 (also referred to as index entries) and disk locations (disk number and block number) have been shown in FIG. 3. The disk block shown in FIG. 6 has a similar format as the disk block format shown in FIG. 4. In the example shown in FIG. 6, each disk has a capacity of 250 GB. Note that even physical hard drives may be larger than 250 GB, they can be partitioned into 250 GB virtual disks, with each assigned its own disk number. Note that the disk numbers should be interleaved such that consecutive numbers address different physical disks. For the standard 4 KB block size, each disk can accommodate up to 64 million index entries, thus requiring an index of at least 26 bits long. In the example shown in FIG. 6, the 10-bit disk number field means that there can be up to 1023 disks in the system (0x3FF in the disk number field is an invalid entry). The 26-bit block count field allows 64 million blocks per disk, and the 4-bit block number field allows up to 16 4-KB blocks per Content Object. For the example system operating at 200,000 objects/sec (assuming 64-KB objects), this is around 60,000 seconds (16 hours) of storage. The 34-bit index is sufficient to provide up to Ser. No. 17/179,869,184 table entries, occupying 128 GB of RAM. The operation buffer, which includes entries that are 68-bit long, is also located in the RAM, requiring additional RAM space.

Each entry in operation buffer 620 corresponds to a pending read or write operation. In some embodiments, an operation buffer entry, such as entry 622, includes a packet-pointer (PKT-PTR) field 624 (which can be 15-bit long), an index field 626 (which maps to an entry in index table 606), a next-operation-index field 628, and a number field 630. Packet-pointer field 624 stores a pointer to a packet in packet buffer 640, which allows up to 32,768 in-process packets. Next-operation-index field 628 stores a singly-linked list pointer to a next entry in operation buffer 620 waiting for the same disk operation, if multiple operations are waiting on the same disk block. Number field 630 is similar to number field 312, indicating the sequence number of the block among all blocks occupied by the Content Object. In the example shown in FIG. 6, two operation buffer entries (entry 622 and entry 632) are waiting for the same disk block, and form an operation chain. Both entries have the same index (=47) but different number field (0 and 1, respectively), meaning that they belong to the different blocks of the same Content Object. The pointer stored in next-operation-index field 628 points to entry 632, which waits for the second block of the SH-FH index entry.

The mapping between entries in index table 606 and disk locations (defined by the disk number and the block number) have been shown in FIG. 3. The disk blocks shown in FIG. 6 have a similar format as the disk block format shown in FIG. 4. In the example shown in FIG. 6, each disk has a capacity of 250 GB. Note that even physical hard drives may be larger than 250 GB, they can be partitioned into 250 GB virtual disks, with each assigned its own disk number. Note that the disk numbers should be interleaved so consecutive numbers address different physical disks. For the standard 4 KB block size, each disk can include 64 million index entries, thus requiring an index of at least 26 bits. In the example shown in FIG. 6, the 10-bit disk number field means that there can be up to 1023 disks in the system (0x3FF in the disk number field is an invalid entry). The 26-bit block count field allows 64 million blocks per disk, and the 4-bit block number field allows up to 16 4-KB blocks per Content Object. For the example system operating at 200,000 objects/sec (assuming 64-KB objects), this provides around 60,000 seconds (16 hours) of storage. The 34-bit index is sufficient to provide up to Ser. No. 17/179,869,184 table entries, which occupy 128 GB of RAM. Additional RAM space is need to accommodate the operation buffer which include entries that are 68-bit long.

In some embodiments, the streaming storage may include storage sectors dedicated to popular content. Note that once a Content Object is labeled popular (based on the number of requests or other criteria), it can be moved to a special sector in the streaming storage (such as a particular disk or a set of particular blocks). Content stored within such special sectors has a longer holdtime. In other words, the special sectors do not get over-written as frequently as the rest of the streaming storage. In some embodiments, content stored within the special sector may remain alive for days, weeks, or sometimes permanently. In some embodiments, the system may ensure that any advancement of the tail pointer does not reach such special sectors, thus preventing these special sectors from being over-written in the event of the tail pointer advancement.

### The Algorithm

In order to facilitate direct memory access (DMA) disk reads, the DMA buffer contains a pointer to the in-memory index (which is 34-bit long in the example shown in FIG. 6). The index entry contains a pointer (opindex) to the pending operation buffers. In some embodiments, the system uses 64-bit word aligned index entry, other than the 56-bit index entry shown in FIG. 6. In some embodiments, the system may use a more compact index representation, such as a 40-bit index entry, with 9-bit disk number, 26-bit block number, 4-bit count, and 1-bit validation. In such a situation, it may make sense to have the DMA buffer point to the first pending operation, and the smaller pending operation table point to the 34-bit index table. Note that this alternative scheme requires that additional operations waiting for the same block not added to the head of the list.

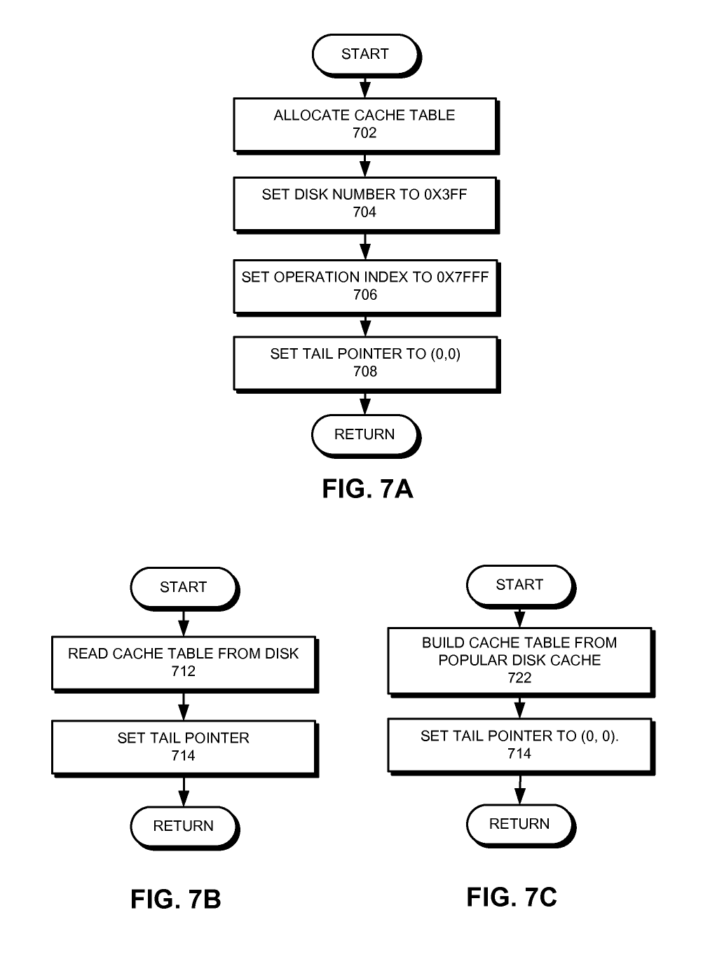

FIG. 7A presents a flowchart illustrating an exemplary first-time initialization process of the streaming storage, in accordance with an embodiment of the present invention. During the first time initialization, the system allocates the in-memory cache table (operation 702). The system sets the disk number in all entries to 0x3FF (or 0x1FF if 9-bit disk number field is used), which indicates an invalid entry (operation 704). Subsequently, the system sets the pending operation index to 0x7FFF, which indicate an invalid entry (operation 706); and sets the tail pointer to disk 0, block 0 (operation 708).

FIG. 7B presents a flowchart illustrating an exemplary initialization process after a clean shut down, in accordance with an embodiment of the present invention. During initialization after a clean shut down, the system reads the in-memory cache table from the disk cache (operation 712), and sets the tail pointer based on information obtained from the disk cache (operation 714).

FIG. 7C presents a flowchart illustrating an exemplary initialization process after a dirty shut down, in accordance with an embodiment of the present invention. During initialization after a dirty shut down, the system builds the in-memory cache table from the popular sector of the disk cache while ignoring all other Content Objects (operation 722), and sets the tail pointer to disk 0, block 0 (operation 724).

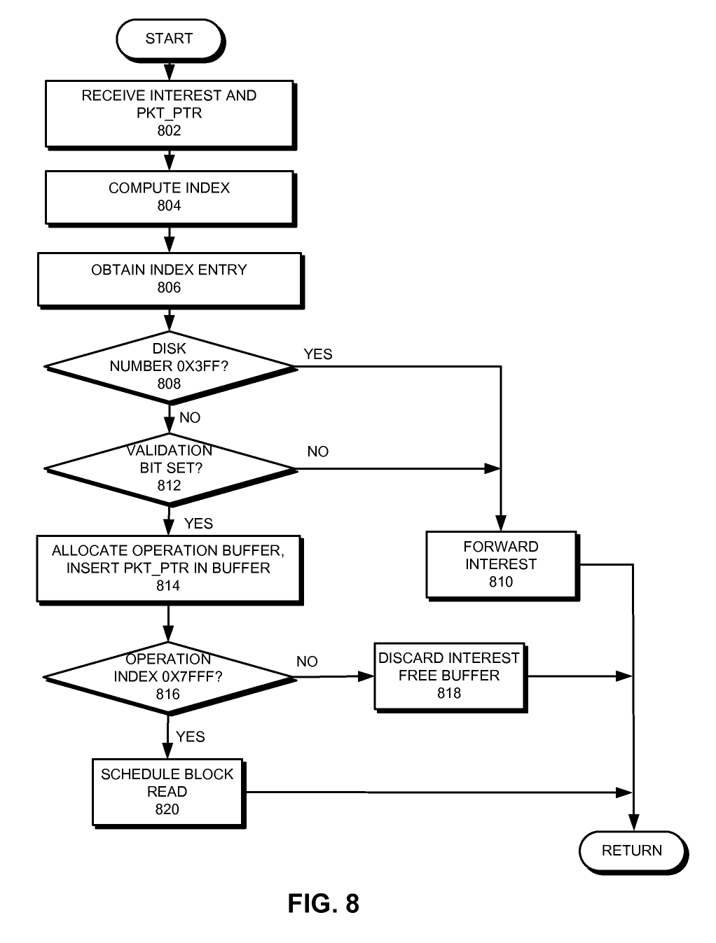

FIG. 8 presents a flowchart illustrating the process of processing an Interest, in accordance with an embodiment of the present invention. During operation, the system receives an Interest packet and a packet pointer to the packet in the packet buffer (operation 802), and computes a shorter-length index (operation 804). In some embodiments, the shorter-length index is computed based on the SH and FH fields included in the packet header. The system then obtains the corresponding index entry from the in-memory cache table based on the computed index (operation 806), and determines whether the disk number included in the index entry is 0x3FF (operation 808). If so, this is a cache miss, the system forwards the Interest as normal (operation 810). Otherwise, the system determines whether the validation bit in the index entry is set (operation 812). If not, not all fragments are available for the corresponding Content Object, the system forwards the Interest as normal (operation 810).

Otherwise, the system allocates an operation buffer and inserts the packet pointer into the operation buffer (operation 814). The system then determines whether the operation index is 0x7FFF (operation 816). If not, there already is a pending operation, the system discards the Interest and free the operation buffer (operation 818). If so, the system schedules the block read to retrieve a corresponding Content Object from the streaming storage (operation 820).

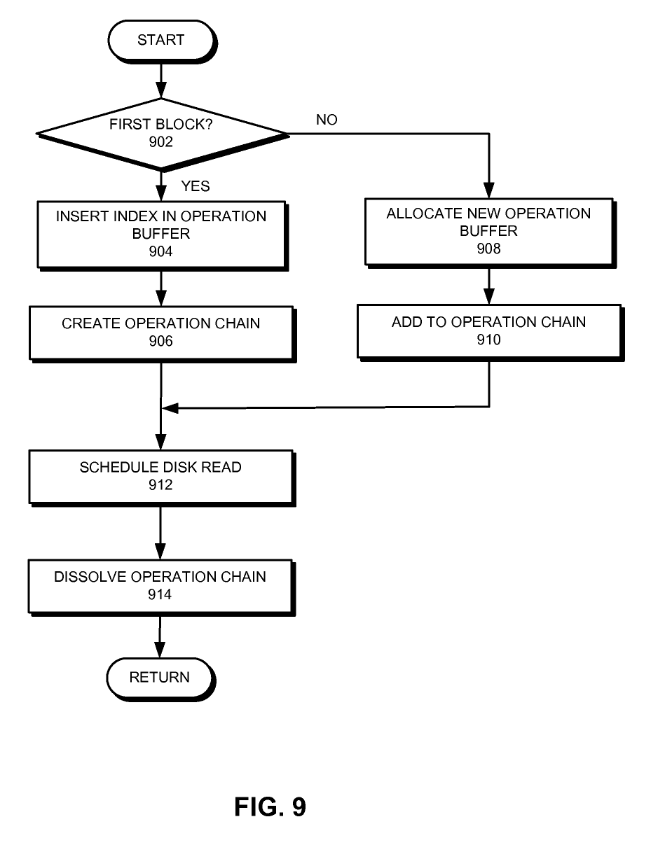

FIG. 9 presents a diagram illustrating a block read process, in accordance with an embodiment of the present invention. During operation, the system first determines whether the current block is the first block of the Content Object (operation 902). If so, the system inserts the computed index in the index field of the operation buffer (operation 904), and creates an operation chain (operation 906). Note that creating the operation chain includes pointing the “next_operation_index” to itself to indicate the current operation buffer is the last buffer in the chain, setting the operation buffer number to 0, and setting the received DMA block with a pointer to operation buffer. Otherwise, the system allocates a new operation buffer for each block (operation 908), and adds it to the operation chain (operation 910). Note that the system sets the index and packet pointer for the following blocks as that of the first operation buffer, and sets the “number” according to the sequence being read. The system then schedule a disk read (operation 912). Once all blocks are read, the system dissolves the operation chain (operation 914).

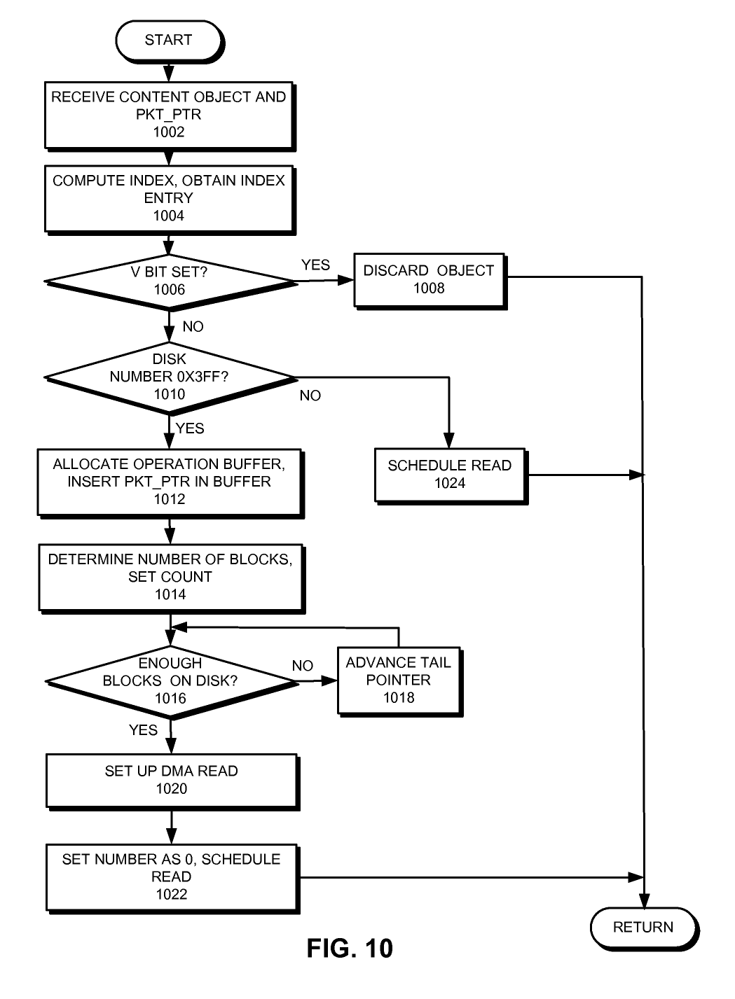

FIG. 10 presents a diagram illustrating the process of processing a received Content Object in the streaming storage, in accordance with an embodiment of the present invention. During operation, the system receives a Content Object and a packet pointer to the packet in the packet buffer (operation 1002). Note that, it is possible that the received content packet is a fragment of the Content Object. The fragment should have the complete SH and FH fields. The system computes the shorter-length index and obtains the index entry from the in-memory cache table based on the computed index (operation 1004). The system determines whether the validation flag in the index entry is set (operation 1006). If so, all fragments of the Content Objects have been received, the system discards the Content Object (operation 1008). Otherwise, the system determines whether the disk number for the index entry is 0x3FF (operation 1010). If so, this is a cache miss, the system allocates an operation buffer and inserts the packet pointer in the operation buffer (operation 1012).

Subsequently, the system determines the number of storage blocks needed for storing the Content Object and sets the count field in the index entry (operation 1014). In some embodiments, the packet length can be determined based on the TLV field included in the packet header. In some embodiments, in situations where fragmentation is applied, the system can make the worst-case estimation of the packet length by multiplying the total fragment count (as indicated by the fragment header) with the fragment maximum transmission unit (MTU). Note that the number of blocks needed can be calculated as the packet length divided by the block size (such as 4 KB). The system then determines whether the number of consecutive blocks (starting from the current tail pointer) available on the disk is less than the calculated “count” number (operation 1016). If so, the system advances the tail pointer until enough number of consecutive blocks are available (operation 1018). In some embodiments, the tail pointer includes a disk number field and a block number field, and the disk number field can be the first one to be advanced. Different algorithms can be used to determine how to advance the tail pointer. In some embodiments, the tail pointer may not be advanced to a sector where the popular content is cached.

The system then sets up a DMA read (operation 1020). Note that setting up the DMA read involves setting up a DMA buffer that points to the index. The system then sets the number field in the operation buffer as 0 and schedule a disk read of the first block (operation 1022). Note that the purpose of this disk read operation is to read and invalidate the Content Object being over-written.

If the disk number is not 0x3FF, the Content Object (or at least part of it), is in the cache, the system schedules a disk read for the blocks (1024). Note that the tail pointer is not advanced in this situation. In some embodiments, during the DMA read, the system first determines whether the operation index is 0x7FFF. If so, the system fills in the operation index with this operation buffer, and schedule a disk read from the first block (block 0). Otherwise, there are other pending write operations (the validation field is not set), the system sets the number field to 0 in the operation buffer and insert the operation buffer to the end of the operation chain. Note that this may result in multiple operation buffer entries with different packet pointers waiting for a read on the same block.

Once the system completes a DMA read (as the scheduled DMA reads shown in FIGS. 8 and 10), the system may perform the following operations based on the DMA read result. For example, for a DMA read in response to an Interest, the system may determine whether the retrieved content data (blocks read) is valid. On the other hand, for a DMA read in response to a Content Object, the system may determine whether to over write the existing data (blocks read) on the disk.

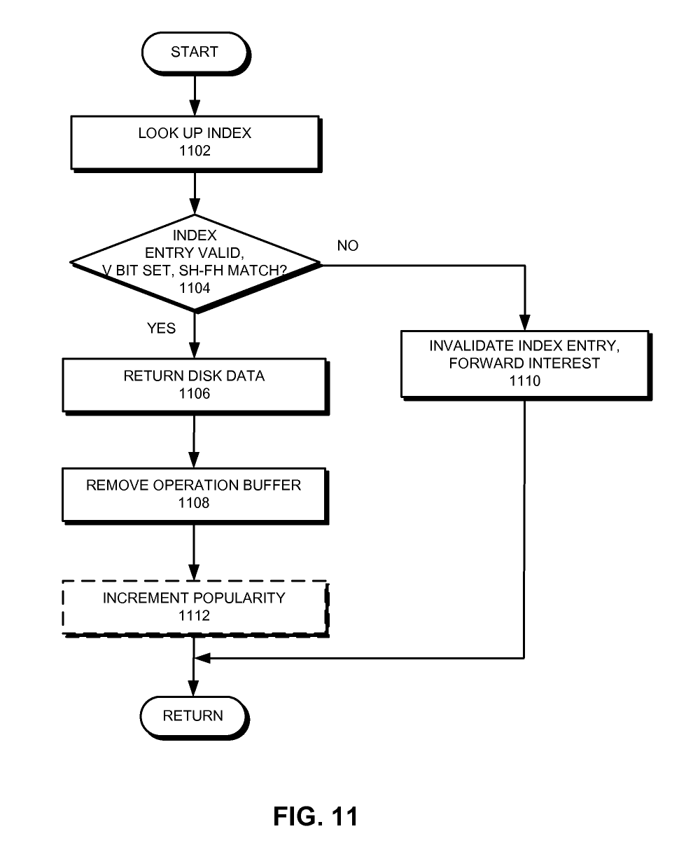

FIG. 11 presents a diagram illustrating an exemplary verification process after a DMA read in response to an Interest, in accordance with an embodiment of the present invention. Once the DMA read for an operation chain is completed, the system looks up the index from the DMA blocks (operation 1102). Note that the index is included in the disk block header, as shown in FIGS. 3-4. Also, note that the following operations are iterated through all the operation buffer entries pointed to by the operation chain. For each block with the number field matches the number field in the operation buffer entry, the system verifies whether the index entry is valid, the verification bit is set, and the SH-FH field matches (operation 1104). To determine whether the SH-FH field matches, the system hashes the SH-FH combination in the DMA block and compares the hash with the index of the Interest. If so, the system returns the disk data (extracted from the block read minus the disk header) as the Content Object or fragments of the Content Object (operation 1106). Note that the disk data are well-formed CCN objects or object fragments, and no further process will be needed before return them to requesters along the Interest reverse path. Also, note that the fragments are returned in the order they were written into the disk, and hence, may be out of order. The system then removes the operation buffer from the chain (operation 1108). Otherwise, this is a miss (the data does not match the Interest), the system invalidate the index entry, and forward the Interest as normal (operation 1110). Note that, if the system performs popularity measures, the system may increment the block's popularity level once the disk data is returned (operation 1112). As discussed previously, frequently requested content has a higher chance of being moved to a “popular” disk sector, where they are less likely to be over-written. Detailed descriptions of determinations of the content popularity can be found in U.S. patent application Ser. No. TBA (Attorney Docket No. PARC-20130999US01), entitled “SYSTEM AND METHOD FOR RANKING CONTENT POPULARITY IN A CONTENT-CENTRIC NETWORK,” by inventor Marc E. Mosko, filed 10 Mar. 2014, the disclosure of which herein is incorporated by reference in its entirety.

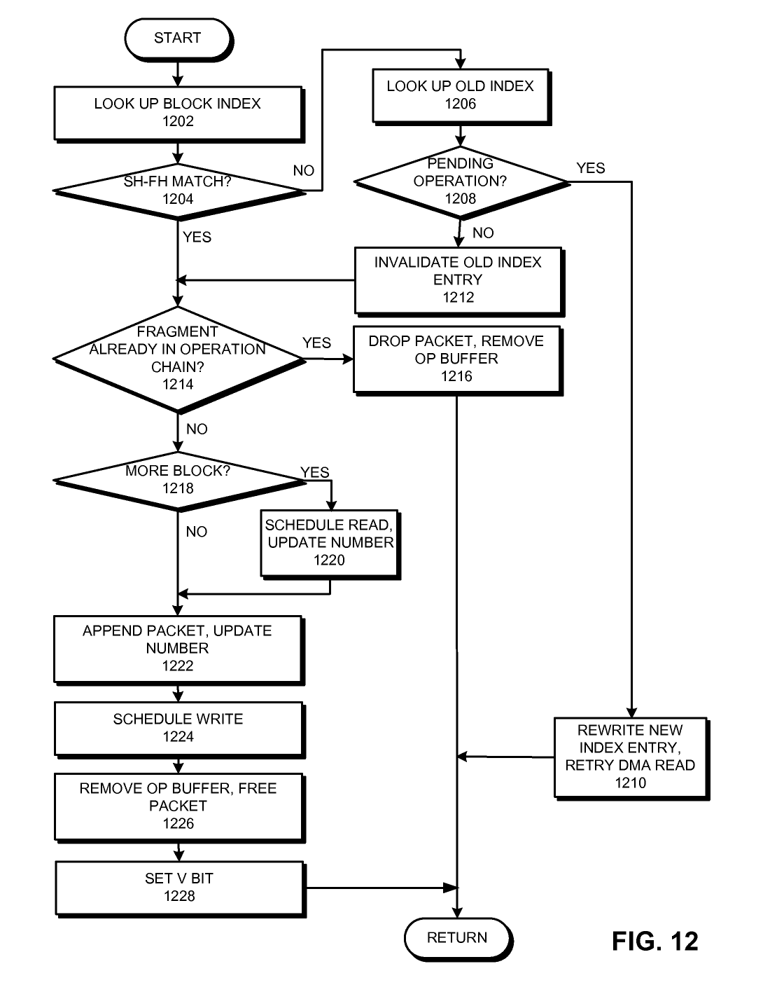

FIG. 12 presents a diagram illustrating an exemplary system process after a DMA read in response to a Content Object, in accordance with an embodiment of the present invention. Once the DMA read for an operation chain is completed, the system looks up the index from the DMA blocks (operation 1202). The following operations are iterated through all the operation buffer entries pointed to by the operation chain. For each block with the number field matches the number field in the operation buffer entry, the system verifies whether the SH-FH field of the DMA block matches the new index (operation 1204). Note that there may be multiple entries with the matching number field. The new index refers to the index of the Content Object being written. If not, the content on the disk is being over-written, the system looks up the old index pointed to by the disk block (operation 1206). Note that the over-writing should only happen when block 0 of a new Content Object is written. Based on the old index, the system determines whether there are pending operations (operation 1208). Note that these should only be read operations. If so, the system re-writes the new index entry in the cache table with the current tail pointer (updating the disk field and the block field), and retries the DMA read (operation 1210). This means the system has decided to write the new content somewhere else because the current blocks are being read (most likely serving an Interest). Otherwise, the system invalidates the old index entry, and continues the operations as if the SH-FH matches the new index (operation 1212).

If the SH-FH in the DMA block matches the new index, the system then checks the CCN headers included in the content packet to determine if the fragment pointed to by the packet pointer exists in the operation chain (operation 1214). If so, it is a duplicate, the system drops the packet and removes the operation buffer entry (operation 1216). If not, the system determines whether there are more blocks (operation 1218). If so, the system schedules a read for the next block and updates the number field (operation 1220). If no more blocks, the system appends the packet (pointed to by the packet pointer) to one of the blocks with enough space for it and updates the number field (operation 1222). After matching all Content Object entries for the original number fields, the system schedules disk writes for any updated blocks (operation 1224). Once the disk writes are completed, the system removes the operation buffer and frees the packet (operation 1226). The system sets the validation bit after the last fragment of the Content Object is written (operation 1228).

### Computer and Communication System

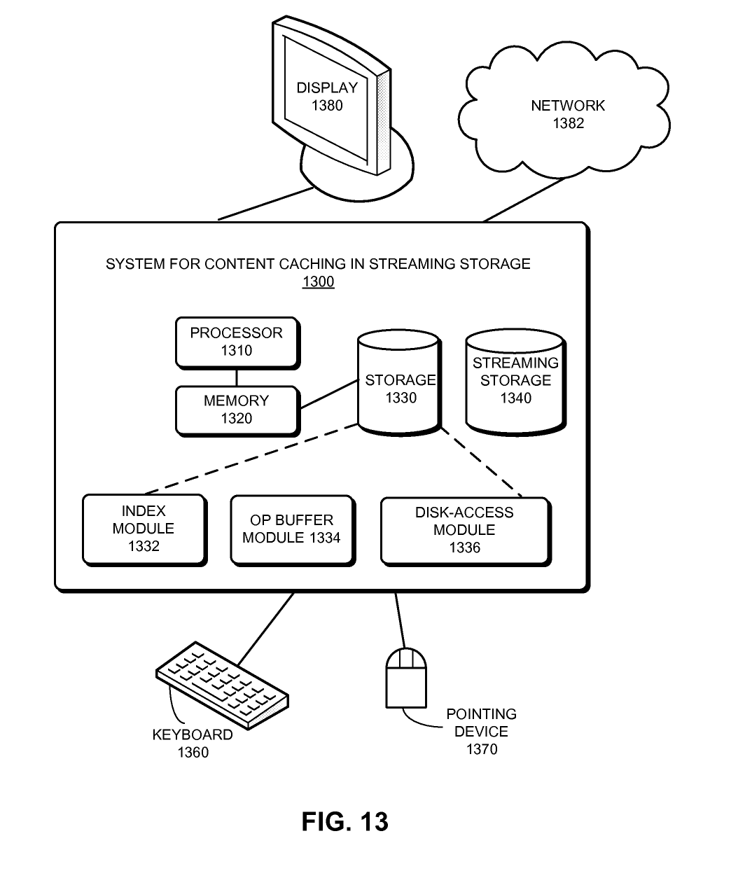

FIG. 13 illustrates an exemplary system for content caching in a streaming storage, in accordance with an embodiment. A system 1300 for content caching in a streaming storage comprises a processor 1310, a memory 1320, and a storage 1330. Storage 1330 typically stores instructions which can be loaded into memory 1320 and executed by processor 1310 to perform the methods mentioned above. In one embodiment, the instructions in storage 1330 can implement an index module 1332, an operation buffer module 1334, and a disk-access module 1336, all of which can be in communication with each other through various means.

In some embodiments, modules 1332, 1334, and 1336 can be partially or entirely implemented in hardware and can be part of processor 1310. Further, in some embodiments, the system may not include a separate processor and memory. Instead, in addition to performing their specific tasks, modules 1332, 1334, and 1336, either separately or in concert, may be part of general- or special-purpose computation engines.

Storage 1330 stores programs to be executed by processor 1310. Specifically, storage 1330 stores a program that implements a system (application) for content caching in a steaming storage, such as streaming storage 1340. During operation, the application program can be loaded from storage 1330 into memory 1320 and executed by processor 1310. As a result, system 1300 can perform the functions described above. System 1300 can be coupled to an optional display 1380, keyboard 1360, and pointing device 1370, and also be coupled via one or more network interfaces to network 1382.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The above description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

What is claimed is:

1. A computer-executable method for caching content data to a streaming storage in a content-centric network (CCN), the method comprising:
maintaining an in-memory index table, wherein a respective entry in the index table specifies a disk location in the streaming storage;
receiving a content packet;
calculating an index for the content packet based on one or more header fields included in the content packet;
mapping the calculated index to a corresponding entry in the in-memory index table;
writing the content packet into the streaming storage; and
updating the mapped entry in the in-memory index table based on a disk location to which the content packet is written.

2. The method of claim 1, further comprising maintaining an in-memory operation buffer configured to reference pending disk operations.

3. The method of claim 2, wherein the in-memory operation buffer includes a linked list identifying a set of pending disk operations on a same block in the streaming storage.

4. The method of claim 1, wherein the one or more header fields include at least one of: a similarity hash and a forwarding hash.

5. The method of claim 4, wherein calculating the index involves hashing a combination of the similarity hash and the forwarding hash to a shorter-length string.

6. The method of claim 1, further comprising:
maintaining a tail pointer configured to point to a next available disk location for writing the content packet; and
updating the tail pointer subsequent to writing the content packet in the streaming storage.

7. The method of claim 1, wherein the streaming storage includes a plurality of disks, and wherein the respective entry in the index table includes a disk number and a block number.

8. The method of claim 1, further comprising:
receiving an interest packet;
calculating an index of the interest packet;
mapping the index of the interest packet to an entry in the in-memory index table;
extracting a disk location from the entry mapped to the index of the interest;
reading content data stored at the extracted disk location; and
returning the content data as a response to the interest packet.

9. The method of claim 8, further comprising:
increasing a popularity level associated with the content data; and
in response to determining that the popularity level associated with the content data being higher than a predetermined level, moving the content data to a popular sector within the streaming storage to prevent future over-written of the content data.

10. An system for caching content data to a streaming storage in a content-centric network (CCN), the system comprising:
a processor; and
a second storage device coupled to the processor and storing instructions which when executed by the processor cause the processor to perform a method, the method comprising:
maintaining an in-memory index table, wherein a respective entry in the index table specifies a disk location in the streaming storage;
receiving a content packet;
calculating an index for the content packet based on one or more header fields included in the content packet;
mapping the calculated index to a corresponding entry in the in-memory index table;
writing the content packet into the streaming storage; and
updating the mapped entry in the in-memory index table based on a disk location to which the content packet is written.

11. The system of claim 10, wherein the method further comprises maintaining an in-memory operation buffer configured to reference pending disk operations.

12. The system of claim 11, wherein the in-memory operation buffer includes a linked list identifying a set of pending disk operations on a same block in the streaming storage.

13. The system of claim 10, wherein the one or more header fields include at least one of: a similarity hash and a forwarding hash.

14. The system of claim 13, wherein calculating the index involves hashing a combination of the similarity hash and the forwarding hash to a shorter-length string.

15. The system of claim 10, wherein the method further comprises:
maintaining a tail pointer configured to point to a next available disk location for writing the content packet; and
updating the tail pointer subsequent to writing the content packet in the streaming storage.

16. The system of claim 10, wherein the streaming storage includes a plurality of disks, and wherein the respective entry in the index table includes a disk number and a block number.

17. The system of claim 10, wherein the method further comprises:
receiving an interest packet;
calculating an index of the interest packet;
mapping the index of the interest packet to an entry in the in-memory index table;
extracting a disk location from the entry mapped to the index of the interest;
reading content data stored at the extracted disk location; and
returning the content data as a response to the interest packet.

18. The system of claim 17, wherein the method further comprises:
increasing a popularity level associated with the content data; and
in response to determining that the popularity level associated with the content data being higher than a predetermined level, moving the content data to a popular sector within the streaming storage to prevent future over-written of the content data.

19. A non-transitory computer-readable storage medium storing instructions that when executed by a computer cause the computer to perform a method for caching content data to a streaming storage in a content-centric network (CCN), the method comprising:
maintaining an in-memory index table, wherein a respective entry in the index table specifies a disk location in the streaming storage;
receiving a content packet;
calculating an index for the content packet based on one or more header fields included in the content packet;
mapping the calculated index to a corresponding entry in the in-memory index table;
writing the content packet into the streaming storage; and
updating the mapped entry in the in-memory index table based on a disk location to which the content packet is written.

20. The computer-readable storage medium of claim 19, wherein the method further comprises maintaining an in-memory operation buffer configured to reference pending disk operations.

21. The computer-readable storage medium of claim 20, wherein the in-memory operation buffer includes a linked list identifying a set of pending disk operations on a same block in the streaming storage.

22. The computer-readable storage medium of claim 19, wherein the one or more header fields include at least one of: a similarity hash and a forwarding hash.

23. The computer-readable storage medium of claim 22, wherein calculating the index involves hashing a combination of the similarity hash and the forwarding hash to a shorter-length string.

24. The computer-readable storage medium of claim 19, wherein the method further comprises:
maintaining a tail pointer configured to point to a next available disk location for writing the content packet; and
updating the tail pointer subsequent to writing the content packet in the streaming storage.

25. The computer-readable storage medium of claim 19, wherein the streaming storage includes a plurality of disks, and wherein the respective entry in the index table includes a disk number and a block number.

26. The computer-readable storage medium of claim 19, wherein the method further comprises:
receiving an interest packet;
calculating an index of the interest packet;
mapping the index of the interest packet to an entry in the in-memory index table;
extracting a disk location from the entry mapped to the index of the interest;
reading content data stored at the extracted disk location; and
returning the content data as a response to the interest packet.

27. The computer-readable storage medium of claim 26, wherein the method further comprises:
increasing a popularity level associated with the content data; and
in response to determining that the popularity level associated with the content data being higher than a predetermined level, moving the content data to a popular sector within the streaming storage to prevent future over-written of the content data.
